(19) United States
(12) Patent Application Publication
(10) Pub. No.: US 2014/0274296 A1
(43) Pub. Date: Sep. 18, 2014

(54) SLOTS GAME

(71) Applicant: GAMES WAREHOUSE, LTD., Pride Park (GB)

(72) Inventor: Colin TROY, Pride Park (GB)

(73) Assignee: GAMES WAREHOUSE, LTD., Pride Park (GB)

(21) Appl. No.: 14/215,558

(22) Filed: Mar. 17, 2014

Related U.S. Application Data
(60) Provisional application No. 61/788,325, filed on Mar. 15, 2013.

(51) Int. Cl. G07F 17/34

(52) U.S. Cl. CPC G07F 17/34
USPC 463/20

(57) ABSTRACT

A slot machine game having a first reel having a first set of symbols/indicia thereon, a second reel having a second set of symbols/indicia thereon and a third reel having a third set of symbols/indicia thereon. The first, second, and third reels being operatively configured to spin based upon an initiation button/lever and stop spinning based upon a random generator. The slot machine game being configured to determine a win based upon any three consecutive matching symbols/indicia on the first, second and third reels relative to the adjacent reels.

### CROSS-REFERENCE TO RELATED APPLICATIONS

This application claims priority to U.S. Provisional Application No. 61/788,325, entitled “Slots Game,” currently pending, filed on Mar. 15, 2013, the entire contents of which are incorporated by reference herein.

### BACKGROUND OF THE INVENTION

Slot machine games are generally known. However, there is no standard set of winning lines across slot game providers. Thus, for each new game, a player must either learn the winning line patterns for that game or accept that the patterns that he/she is shown during game play are the ones in the rules screen. Thus, in conventional games involving winning lines, players generally cannot easily determine what constitutes a winning line without referring to a protracted help screen menu.

This problem is compounded by the irregularity of winning lines across different games. Conventionally, across all games, there is a standard for the first set of five lines, with lines 1 to 3 being straight horizontal lines with lines 4 and 5 making a V and inverted V shape respectively. Beyond that, there generally is no standard, although some patterns tend to be ubiquitous across slots games. A further complication is that when an even number of winning lines is offered, the last line is generally an ‘odd’ line because the first five liners are standard. That is, the last line does not have any “mirror image” line on the horizontal axis.

Another source of confusion for these types of games arises when the game is configured to have symbols drop in. In such games, a so-called “phantom wins effect” tends to occurs. That is, as players are playing the game, they instinctively imagine or think of what the winning lines are. In games with only a few lines, the winning lines are generally known. However, in the case of a game with 20 or more lines, it is difficult to remember all of the possible winning combinations. Therefore, over the course of game play, players tend to imagine where the wining lines may be, especially if the line could be where the symbols are currently dropping in. Such a phenomena is likely caused by a false sense of hope influencing the player's memory. Thus, players tend to think they have a winning combination, when in fact they do not. The result is that players are left disappointed with the game play.

To confound the above-described effect further, the more winning lines there are, the harder it is to keep track of which lines are real and which are imaginary. For example, FIG. 1 depicts a prior art game including a typical set of 20 win-lines. Of the patterns shown in FIG. 1, Pattern No. 6 is active (from left to right) on top, middle, top, middle and top. However there is no corresponding transposition for middle, bottom, middle, bottom and middle. A similar situation occurs in Pattern Nos. 7, 8, 9, 14 and 15. Also, Pattern Nos. 18 and 19 seem disjointed compared to the rest of the patterns. Finally, Pattern No. 20 has no mirror image because Pattern Nos. 1, 2, and 3 ensure that the player always has a pattern with no complement if there are an even number of win-lines. However, with respect to mirror images, there is no standard for whether the patterns will be symmetrical or not. For example, Pattern Nos. 16 to 19 are not symmetrical, while Pattern Nos. 12 and 13 are symmetrical about the diagonals and all other patterns are symmetrical about the vertical axis.

With the above patterns, it is easy to envision how a player may lose track of which combinations pay out and which do not. It is also feasible to envision how some combinations will appear to be wins even when they are not, because the symbols will produce the same pattern as a winning combination but transposed by one reel position.

Another known game system, shown in FIG. 2, provides players with 720 ways to win. The game system does so via a hexagonal shaped set of discrete symbols. The lines do not match up in a horizontal manner, but rather in diagonals. The win-lines are also payable from left to right and right to left. Finally, any three or more adjacent symbols provide a win. Therefore, there are 3×4×5×4×3 win-lines, which totals 720 win-lines. This system involves the multiplication of wins through the repetition of symbols that appear in the same column.

For example, one convention is that multiple of the same symbol in any column is a multiplier of the line. For example, in one system, having three reels where any symbol on reel 1 matches with a pair anywhere on reels 2 and 3 results in a win, as shown in FIG. 3. This gives 27 win-lines (3×3×3). If there are two of the same symbol in any column, then the player has two win-lines, as shown in FIG. 4. However such a system is confusing when there are two ‘X’ symbols in each column (multiplier=2×2×2=8). The system is generally too mathematical for the average person.

Accordingly, it would be beneficial to provide a succinct set of rules for determination of winning lines. It would also be beneficial to present those rules to the player and ensure that they are easy to understand and transform into patterns.

### BRIEF SUMMARY OF THE INVENTION

A preferred embodiment of the present invention is directed to a slot machine game having a first reel having a first set of symbols/indicia thereon, a second reel having a second set of symbols/indicia thereon and a third reel having a third set of symbols/indicia thereon. The first, second, and third reels being operatively configured to spin based upon an initiation button/lever and stop spinning based upon a random generator. The slot machine game being configured to determine a win based upon any three consecutive matching symbols/indicia on the first, second and third reels relative to the adjacent reels.

### BRIEF DESCRIPTION OF THE DRAWINGS

The foregoing and other aspects of the invention will be better understood from the following detailed description of the invention, which is provided in connection with the accompanying drawings, in which:

FIG. 1 is a diagram of a slot machine game in accordance with an embodiment of the invention;

FIG. 2 is a diagram of a slot machine game having a hexagonal shaped set of discrete symbols in accordance with an embodiment of the invention;

FIG. 3 is a diagram of a slot machine game having 5 reels in accordance with an embodiment of the invention;

FIG. 4 is a diagram of a slot machine game having in accordance with an embodiment of the invention;

FIG. 5 is a diagram of a slot machine game having 5 reels in accordance with an embodiment of the invention;

FIG. 6 is a diagram of a slot machine game in accordance with an embodiment of the invention;

FIG. 7 is a diagram of a slot machine game in accordance with an embodiment of the invention;

FIG. 8 is a diagram of a slot machine game in accordance with an embodiment of the invention;

FIG. 9 is a diagram of a slot machine game in accordance with an embodiment of the invention; and

FIG. 10 is a diagram of a slot machine game in accordance with an embodiment of the invention.

### DETAILED DESCRIPTION OF THE INVENTION

Certain terminology is used in the following description for convenience only and is not limiting. The words “a” and “an”, as used in the claims and in the corresponding portions of the specification, mean “at least one.” Further, the terms “coin” or “currency” should not be construed as limiting and can be used herein to mean all forms of coin and paper currency from any country as well as proprietary tokens, game cards, credit cards, debit cards, chits, or other representative forms of credit and/or payment.

The present invention is directed to a system for creating winning combinations or win lines. The system involves three core rules. The first rule is that any three consecutive matching symbols/indicia on reels 1 to 3 constitute a win. The second rule is that any fourth or fifth matching symbols/indicia on right hand reels add to the win if these symbols/indicia are symmetrical with those on the left hand reels. The third rule is that if the win is in a straight, horizontal line, then the win value is doubled, a so-called bonus line.

There are three straight horizontal lines on all slots games and these lines are universally known as win-lines 1, 2 and 3. These are the three true lines, in that they do not deviate from their intended path as they cross the reels from left to right. Therefore, the third rule introduces the concept of providing a satisfactory number of win-lines, while simultaneously adding a special ability to three of the win-lines. This behavior attributable to lines 1, 2 and 3 only, and results in any wins on these lines being doubled. Thus, with the third rule, three lines effectively become six lines (2 lines crossing the same pathway×3). There are also 24 remaining lines that deviate from the universal win-lines.

Thus, according to the present invention, any win checking strategy should keep multipliers to a minimum whenever possible. This can be done at the stage of designing the reel bands of a game system. More particularly, the reel band can be designed to stop “clumping” of multiple symbols/indicia which, in turn, creates the effect shown in FIG. 4.

Referring to FIG. 3, if the system is extended to 5 reels, then there are 243 resulting win-lines (27×3×3). If, however, the winning combinations are restricted so that they are symmetrical around the vertical axis on reel 3, as per the three core rules, then there is a 27 win-line effect across 5 reels, as shown in FIG. 5.

If all wins are symmetrical around the vertical on reel 3, then it can be said that any combination of 4 or more symbols/indicia that does not continue the symmetry from the first three symbols/indicia will not extend the winning combination further. For example, FIG. 6 depicts a winning combination of only 3 symbols/indicia, according to the three core rules, as the symbols/indicia on reels 4 and 5 do not continue the symmetry from reels 1-3. FIG. 7 depicts a winning combination of only 4 symbols/indicia, according to the three core rules, as the symbol on reel 4 continues the symmetry of reels 1-3, but the symbol on reel 5 does not.

Thus, based on the three core rules for creating a win, all winning combinations are symmetrical around the vertical on reel 3 (i.e., the third reel).

In one embodiment, a special symbol M, hereinafter referred to as the “wild symbol,” appears on one of the reels, preferably only on reel 3. The wild symbol M reflects any symbol ‘n’ discreet reels to the left of the wild symbol M to the discrete reels to the right, or vice versa (i.e., reflects the results of any symbol ‘n’ in discreet reels to the right of the wild symbol M to discrete reels to the left). That is, the wild symbol M reflects what occurs on one side of the reels onto the other side of the reels. The wild symbol M thus replaces any symbol in play, but has the added effect of mirroring everything on the left hand side (reels 1 and 2) onto the right hand side (reels 4 and 5). The ultimate effect of this is to turn wins of 3 symbols/indicia into wins of 4 and 5 symbols/indicia. Specifically, referring to FIG. 8, the wild symbol M in the center of the reel system accounts for any symbol and mirrors all symbols/indicia on the left to the right. If the wild symbol M represented a typical wild symbol (i.e., just accounting for any one symbol), FIG. 8 would represent a wining combination of three Ks. However, since the wild symbol M mirrors the K symbol on reel 2 onto reel 4, and also mirrors the Q symbol on reel 1 onto reel 5, the wining combination is extended out to four Ks.

FIG. 9 depicts another example of the effect of the wild symbol M. Referring to FIG. 9, where there is now another K symbol in the center of reel 2, the effect of the wild symbol M is to create a bonus line of 5×K. Since the win value is doubled for such a bonus line, the win-line is effectively two lines of 5×K.

In another embodiment, an expanding wild symbol may be used instead of the wild symbol M in the center of reel 3. The expanding wild symbol expands onto the entire reel and reflects the results of all symbols/indicia ‘n’ in discreet reels to the left of the expanding wild symbol onto discreet reels to the right, and vice versa (i.e., expands onto the entire reel and reflects the results of any symbols/indicia ‘n’ in discrete reels to the right of the expanding wild symbol onto discrete reels to the left). Thus, when the expanding wild symbol appears, it will expand onto all the other symbol positions for the reel on which it has appeared. Thus, when the expanding wild appears in the center of reel 3, as shown in FIG. 10, it ensures that all wins are symmetrical. That is, the expanding wild symbol ensures that all of the symbols/indicia on reels 1 and 2 will be mirrored onto reels 4 and 5, as shown in FIG. 10. Thus, by using the expanding wild symbol, the same reels in FIG. 9 now look like the reels shown in FIG. 10, with wins of 2 lines of 5×K+1 bonus line of 5×K, 2 lines of 5×A+1 bonus line of 5×A.

While the expanding wild symbol could re-introduce the multiplier effect that the three core rules generally avoid, this effect could still be prevented if multiplier complexities are avoided in the reel design (e.g., no symbol within 3 of itself on any reel).

The above described wild symbol M thus supplements the three core rules with the following fourth and fifth rules. The fourth rule is that if the symbol is in a straight, horizontal line which includes a wild symbol M, the result is two win lines+1 bonus line, or a multiplier of 4. The fifth rule is that if the win line is not a straight, horizontal line which includes a wild symbol M, the result is three win lines, or a multiplier of 3.

The fourth and fifth supplemental rules are not essential and a part of the core rules. Generally, these supplemental rules should only be implemented if a wild symbol M is present in the game. As such, the supplemental rules need not be presented in the help screen, as the win visual itself can be carefully designed to explain what is happening with the wild symbols/indicia M.

Preferably, in the slots gaming system of the present invention, the wins are presented in a humanly logical manner, rather than a numerically logical manner. For example, referring to FIG. 10, the win visual would preferably show the A bonus line (with X 2 splashed on the screen), followed by the other two A lines (from top to bottom.). Then, it would show the K bonus line, followed by the other two K lines (top to bottom.).

Preferably, the slots gaming system can be altered as necessary to meet the requirements and restrictions of the jurisdiction in which it is to be used, particularly for win checks. For example, in some jurisdictions, a centrally-located expanding wild symbol (i.e., the symbol which replaces the symbols/indicia appearing on reels 4 and 5 with the symbols/indicia appearing on reels 2 and 1, respectively) may violate correlation tests and randomness tests, if the game were to literally replace the random number generator (RNG) results of reels 4 and 5 with those of reels 2 and 1. One solution is to alter the win-check so that instead of moving through the reels in 1, 2, 3, 4, 5 order, where there is a wild symbol on reel 3, the win-check would move through the reels as such: 1, 2, 3, 2, 1. Such a win-check is generally literally mirroring the original win. The added bonus is that reels 4 and 5 can still report their original intended stop positions over the SAS system. Visually, the game will show these positions fade out and be replaced with the mirror image of what has appeared on reels 1 and 2.

Any possible theme may be used for the slots game of the present invention. For example, themes of a magic show, mythical magic (e.g., mages, sorcerers, wizards and the like), science fiction parallel dimensions (e.g., surrealistic themes where things are not as they seem), and fairytales (e.g., magic wardrobe, wonderland crossover and the like) may be used for the slots game.

The three core rules ensure that any player, even players who are not existing slots players or who may not be familiar with slots, will be able to understand the rules quickly and easily. The three core rules can also be easily explained by one player to another. Also, as discussed above, the three core rules can be used on any slots theme, with or without wild symbols/indicia. The three core rules also have no technological restrictions.

The three core rules also result in a slots game that guarantees horizontal symmetry across all win-lines about the central reel. The slots game also has a slots win-checking algorithm with the ability to reflect back on itself numerically. This win check capability allows the game to be adapted for particularly strict jurisdictions. The slots game also has a win-checking algorithm that has the ability to count the same reel symbol twice or more to correlate an associated pay value.

In one embodiment, the slots game allows for a scatter win that is symmetrical about the center reel. The scatter win may be active on the first number of reels to the left of the center reel and inclusive of the center reel, which awards larger wins if the pattern on the left hand side of the center reel is partially continued in a symmetrical manner on the right hand reels of the center reel. Alternatively or additionally, the scatter win may be active on the first number of reels to the left of the center reel and inclusive of the center reel, which awards larger wins if the pattern on the left hand side of the center reel is wholly continued in a symmetrical manner on the right hand reels of the center reel. Alternatively or additionally, the scatter win may be active on the first number of reels to the right of the center reel and inclusive of the center reel, which awards larger wins if the pattern on the right hand side of the center reel is partially continued in a symmetrical manner on the left hand reels of the center reel. Alternatively or additionally, the scatter win may be active on the first number of reels to the right of the center reel and inclusive of the center reel, which awards larger wins if the pattern on the right hand side of the center reel is wholly continued in a symmetrical manner on the left hand reels of the center reel.

It will be appreciated by those skilled in the art that changes could be made to the above described preferred embodiment of the clip 10 without departing from the broad inventive concepts thereof. It is understood, therefore, that this invention is not limited to the particular embodiments disclosed, but is intended to cover modifications within the spirit and scope of the present invention as defined herein.

I claim:

1. A slot machine game comprising:
a first reel having a first set of symbols/indicia thereon;
a second reel having a second set of symbols/indicia thereon; and
a third reel having a third set of symbols/indicia thereon, the first, second, and third reels being operatively configured to spin based upon an initiation button/lever and stop spinning based upon a random generator;
the slot machine game being configured to determine a win based upon any three consecutive matching symbols/indicia on the first, second and third reels relative to the adjacent reels.

2. The slot machine game of claim 1, further comprising:
a fourth reel having a fourth set of symbols/indicia thereon; and
a fifth reel having a fifth set of symbols/indicia thereon, the fourth and fifth reels being operatively configured to spin based upon an initiation button/lever and stop spinning based upon a random generator;
the slot machine game being configured to determine a bonus win based upon any matching symbols/indicia on the first and second reels being symmetrical with matching symbols/indicia on the fourth and fifth reels.

3. The slot machine game of claim 1, wherein the slot machine game being configured to determine a bonus win based upon the matching symbols/indicia on the first, second and third reels being in a straight, horizontal line.
